(19) United States
(12) Patent Application Publication
(10) Pub. No.: US 2013/0194172 A1
(43) Pub. Date: Aug. 1, 2013

(54) DISABLING AUTOMATIC DISPLAY SHUTOFF FUNCTION USING FACE DETECTION

(71) Applicant: Shyam T. SHYAMALAN, Hillsborough, NJ (US)

(72) Inventor: Shyam T. SHYAMALAN, Hillsborough, NJ (US)

(73) Assignee: Cellco Partnership d/b/a Verizon Wireless, Basking Ridge, NJ (US)

(21) Appl. No.: 13/361,568

(22) Filed: Jan. 30, 2012

(51) Int. Cl. G06F 3/01

(52) U.S. Cl. 345/156

(57) ABSTRACT

Techniques and equipment for disabling an automatic display shutoff function of a mobile device based on face detection are disclosed. The automatic display shutoff function generally disables or deactivates the display after a predetermined period of time, during which there is no input from a user of the mobile device. An image captured using a front facing camera of the mobile device may be used to detect at least a portion of the user's face and thus, override the automatic display shutoff function before expiration of the period of time without detecting any user input and during execution of an application program associated with the display of information for a time longer than the predetermined period of time.

### BACKGROUND

Modern computing devices, and particularly smart mobile devices (e.g., smart phones, tablets, and laptops), generally provide an automatic display shutoff function that disables the display screen of the device after a certain period of inactivity or use. The primary purpose of this function is to conserve battery life by reducing any additional power consumption associated with a display screen that is active for a prolonged period of time. Accordingly, this function may be useful particularly for smart mobile devices that feature high-resolution display screens but that are usually equipped with batteries of relatively small size and limited capacity.

Unfortunately, the use of this function can also adversely impact user experience, for example, when the user is using the device to perform an activity that generally involves viewing the screen for an extended period of time without requiring frequent interaction with the screen or device. An example of such a user activity may include, but is not limited to, viewing text or images displayed on the screen via an email application, web browser, or document or image viewer executing on the user's device. The automatic shutoff function may hinder user experience related to such a user activity when, for example, the display automatically shuts off before the user has a chance to finish reading a lengthy web page or email.

It is possible for the user to disable automatic display shutoff via, for example, a user preference option in a settings panel of the device operating system. However, this type of user preference typically is global in scope with respect to the device, regardless of the particular application that is currently executing on the device. Furthermore, it would not be beneficial to disable the display shutoff functionality of, for example, a smart mobile device entirely due to the negative impact this would have on battery life for the device, as noted above. It is also possible for the user to prevent the device screen from shutting off by manually interacting with the screen or device (e.g., by touching the screen) on a periodic basis. However, user experience still suffers due to the inconvenience of having to frequently perform such a manual operation merely to prevent the display screen from turning off automatically.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A illustrates an example technique for detecting at least a portion of a user's face based on an image captured using a digital camera of a mobile device.

FIG. 1B illustrates the example technique for detecting at least a portion of a user's face based on an image captured using a digital camera of a personal computer or other workstation device.

FIG. 2A is a high-level functional block diagram of an example mobile device suitable for practicing an implementation of the subject technology.

FIG. 2B is a high-level functional block diagram of an example mobile device having a touch-screen display that is also suitable for practicing an implementation of the subject technology.

FIG. 3 is a process flowchart of an example method for automatically disabling the automatic display shutoff feature or function of a computing device using face detection.

FIG. 4 is a high-level functional block diagram of an example computing device for practicing some implementations of the subject technology.

### DETAILED DESCRIPTION OF PREFERRED EMBODIMENTS

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various techniques and systems disclosed herein relate to automatically disabling the automatic display (or “auto-display”) shutoff feature or function of a computing device using face detection. For example, the automatic display shutoff (or sleep) function may be implemented in a smart mobile device (e.g., smart phone, tablet computer, or laptop computer) to conserve battery the battery life of the device during use. However, the techniques described herein may be implemented in any general purpose computing device including a forward or front-facing digital camera and a similar automatic display shutoff/sleep function.

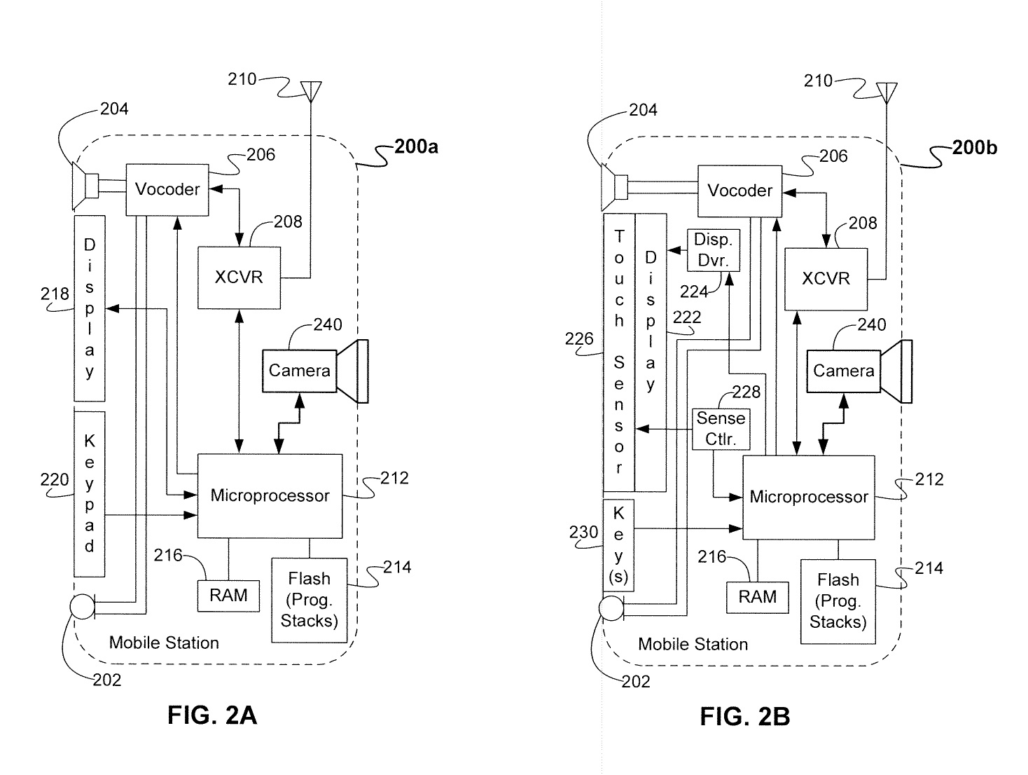

The automatic display shutoff function of a device generally relies on a display timer that automatically deactivates (e.g., by dimming or shutting off) the display screen after a predetermined period of time has elapsed in which no activity or user input is detected. It should be noted that such an auto-display shutoff function, as referred to herein, is not limited to functions that completely disable, shut off or power off the display and may include similar functions that merely dim or reduce a brightness level of the display (e.g., to a predetermined reduced brightness level that may be associated with an operational “standby” or “sleep” mode of the display, as noted previously). The predetermined period of time for maintaining an active display during a period of inactivity may be configurable by the user via, for example, a user settings or control panel of the device. In an example of a device having a touch-screen display (e.g., device 200b of FIG. 2B, as will be described in further detail below), the display timer of the device may be set to a default or user-configured period of time (e.g., 30 seconds), after which the automatic display shutoff function is triggered if no activity has occurred during this period of time. The activity needed to reset the display timer before the screen is deactivated is typically in the form of user input (e.g., the user touching the display screen during the relevant period of time). Additionally, such activity may also include, for example, input in the form of a communication or request received at the device from an external device, application program or service that may be communicating with an application program or service executing at the device (e.g., over a network).

To avoid undesired consequences associated with the auto-display shutoff function disabling the display screen while the user has not finished viewing the information being displayed, the techniques described herein operate by disabling the automatic display shutoff feature if a person's face is detected by a front-facing camera of the device. Accordingly, face detection is used to provide the device with an indication that the user is still viewing the display screen and therefore, to not disable or deactivate the display screen. The face detected by the camera does not have to be the user of the device or even the same person during the same period of use. However, in some implementations, the device may be configured to recognize a particular user's face and enable the automatic display-shutoff override function, as described herein, only upon successful face detection and recognition of the particular user's face. It should be noted that any one or a combination of various facial detection and/or facial recognition algorithms may be used as desired. Further, any example facial detection or recognition algorithms are provided for illustrative purposes and the techniques described herein are not intended to be limited thereto. Reference now is made in detail to the examples illustrated in the accompanying drawings and discussed below.

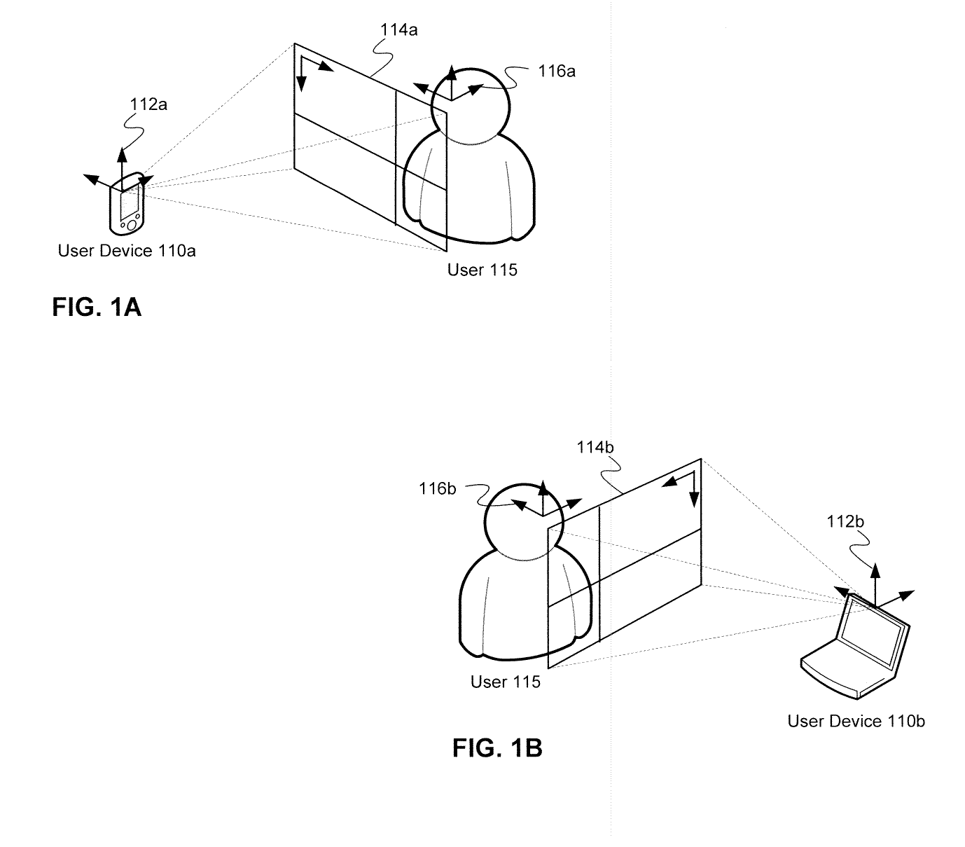

FIGS. 1A and 1B illustrate an example technique for face-detection using a digital camera integrated with a computing device of a user 115. In particular, FIG. 1A illustrates the example technique implemented using a user device 110a (e.g., a mobile device). FIG. 1B illustrates the example technique implemented using a user device 110b (e.g., a personal computer or workstation) of the user 115. However, it should be noted that user device 110a and user device 110b (hereinafter “user devices 110a-b”) of FIGS. 1A and 1B, respectively, can each be any type of computing device with at least one processor, local memory, display, and one or more input devices (e.g., a mouse, QWERTY keyboard, touch-screen, microphone, or a T9 keyboard). Examples of different computing devices that may be used to implement either of user devices 110a-b include, but are not limited to, a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Alternatively, each of user devices 110a-b can be a specialized computing device such as, for example, a mobile handset or tablet computer.

In the examples illustrated in FIGS. 1A and 1B, user devices 110a-b each include a digital camera that can be used for detecting at least a portion of the user's 115 face. As described above, user devices 110a-b may each use any one or a combination of various facial recognition techniques for this purpose. As shown in FIGS. 1A and 1B, a portion of the user's 115 face or other user (not shown) may be detected by each of user device 110a-b based on one or more digital images 114a-b captured by the digital camera of each of the respective user devices 110a-b. The digital camera may be, for example, integrated with the user devices 110a-b or an external camera (e.g., a web camera) that is communicatively coupled to the user devices 110a-b. Further, the facial detection technique used by user devices 110a-b may be based on a single image or a series of images (e.g., a video) captured by the digital camera. For example, if an initial image captured by the camera is of insufficient quality to detect the user's 115 face successfully, one or more subsequent images may be captured as may be desired in order to improve image quality and reattempt the face detection process. Accordingly, these algorithms may take into account variations in the captured image or video including, but not limited to, the portions of the face that have been captured, the lighting or other factor affecting the quality of the captured image and whether the relative position of the face being detected in the captured image(s) corresponds to a person's face who is actively viewing the display, as will be described in further detail below. In addition, such algorithms may use pattern classification techniques to differentiate between the face and background portions of the captured image. As noted above, any human face appearing in the camera's view may be detected and that the techniques are not limited to detecting the user's 115 face, specifically.

As noted above, various face detection algorithms may be utilized by user devices 110a-b to detect the front of a human face (e.g., of user 115 or another user) from different viewpoints with respect to the position of the camera. In the example, as shown in FIGS. 1A and 1B, the images 114a-b captured by user devices 110a-b may be segmented into different portions based on the position of the user's 115 head or face relative to the position of the digital camera of each of user devices 110a-b. For example, the aforementioned face detection algorithms may determine the position of the user's 115 head or face based on Cartesian three-dimensional coordinates 116a-b relative to the camera's position as measured by Cartesian three-dimensional coordinates 112a-b. Further, the determined position of the user's 115 head or face in three-dimensional space may be mapped to the two-dimensional space corresponding to images 114a-b. As such, user devices 110a-b may use captured image(s) 114a-b to isolate and track a portion of the user's 115 face for purposes of real-time facial detection and/or facial recognition.

FIGS. 2A and 2B illustrate general block diagrams of mobile devices in the form of mobile handsets. In particular, FIG. 2A provides a block diagram illustration of an exemplary non-touch type mobile device 200a. FIG. 2B depicts a touch-screen type mobile device 200b (e.g., a smart phone device), as will be discussed later. For example, the relevant functional elements/aspects of user device 110a may be implemented using the example mobile devices/devices 200a and 200b illustrated in FIGS. 2A and 2B, respectively.

For purposes of such a discussion, FIG. 2A provides a block diagram illustration of an exemplary mobile device 200a that does not have a touch-screen display interface (i.e., a non-touch type mobile device). Although the mobile device 200a may be a smart-phone or may be incorporated into another device, such as a personal digital assistant (PDA) or the like, for discussion purposes, the illustration shows the mobile device 200a is in the form of a handset. A handset implementation of the mobile device 200a functions as a digital wireless telephone station. For that function, mobile device 200a includes a microphone 202 for audio signal input and a speaker 204 for audio signal output. The microphone 202 and speaker 204 connect to voice coding and decoding circuitry (vocoder) 206. For a voice telephone call, for example, the vocoder 206 provides two-way conversion between analog audio signals representing speech or other audio and digital samples at a compressed bit rate compatible with the digital protocol of wireless telephone network communications or voice over packet (Internet Protocol) communications.

For digital wireless communications, the mobile device 200a (e.g., implemented as a mobile handset) also includes at least one digital transceiver (XCVR) 208. To function appropriately in modern mobile communications networks, the mobile device 200a would be configured for digital wireless communications using one or more of the common network technology types. The concepts discussed here encompass embodiments of the mobile device 200a utilizing any digital transceivers that conform to current or future developed digital wireless communication standards. Mobile device 200a may also be capable of analog operation via a legacy network technology.

The transceiver 208 provides two-way wireless communication of information, such as vocoded speech samples and/or digital information, in accordance with the technology of a network. The network may be any network or combination of networks that can carry data communication. Such a network can include, but is not limited to, a cellular network, a local area network, medium area network, and/or wide area network such as the Internet, or a combination thereof for communicatively coupling any number of mobile clients, fixed clients, and servers. The transceiver 208 also sends and receives a variety of signaling messages in support of the various voice and data services provided via the mobile device 200a and the communication network. Each transceiver 208 connects through RF send and receive amplifiers (not separately shown) to an antenna 210. The transceiver may also support various types of mobile messaging services, such as short message service (SMS), enhanced messaging service (EMS) and/or multimedia messaging service (MMS).

The mobile device 200a includes a display 218 for displaying messages, menus or the like, call related information dialed by the user, calling party numbers. A keypad 220 enables dialing digits for voice and/or data calls as well as generating selection inputs, for example, as may be keyed-in by the user based on a displayed menu or as a cursor control and selection of a highlighted item on a displayed screen. The display 218 and keypad 220 are the physical elements providing a textual or graphical user interface. Various combinations of the keypad 220, display 218, microphone 202 and speaker 204 may be used as the physical input output elements of the graphical user interface (GUI), for multimedia (e.g., audio and/or video) communications. Of course other user interface elements may be used, such as a trackball, as in some types of PDAs or smart phones.

In addition to general telephone and data communication related input/output (including message input and message display functions), the user interface elements also may be used for display of menus and other information to the user and user input of selections, including any needed during the execution of a client application, invoked by the user to access one or more advanced data or web services provided by the carrier, as discussed previously. As will described in further detail below, mobile device 200a includes a processor and programming stored in device memory, which is used to configure the processor so that the mobile device is capable of performing various desired functions, including functions involved in delivering enhanced data services provided by the carrier via the client application.

In the example device shown in FIG. 2A, a microprocessor 212 serves as a programmable controller for mobile device 200a. Microprocessor 212 is configured to control all operations of the mobile devices/devices including any operations associated with one or more client applications that it executes. Further, microprocessor 212 performs any operations in accordance with programming associated with such client application(s) in addition to other standard operations in general for the device.

Also as shown in FIG. 2A, mobile device 200a includes flash type program memory 214, for storage of various “software” or “firmware” program routines and mobile configuration settings, for example and without limitation, the mobile directory number (MDN) and/or mobile identification number (MIN). Mobile device 200a may also include a non-volatile random access memory (RAM) 216 for a working data processing memory. Other storage devices or configurations may be added to or substituted for those in the example. In an example, a flash-based program memory 214 stores firmware (including a device boot routine), device driver software, an operating system, processing software for client application functions/routines and any control software specific to the carrier or mobile device. In operation, the programming associated with the boot routine stored in flash memory 214 (i.e., the firmware) is loaded into (e.g., into cache memory of microprocessor 212) and executed by the microprocessor 212, for example, when the device is power-cycled or reset. Memory 214 may also be used to store any of a wide variety of other applications, for example and without limitation, a web browser applications and messaging service applications for sending and receiving text and/or multimedia messages. Memory devices 214 and 216 can also be used to store various data, such as telephone numbers and server addresses, downloaded data such as multimedia content, and various data input by the user.

In the illustrated example, the mobile device 200a also includes a digital camera 240, for capturing still images and/or video clips. Although digital camera 240 is shown as an integrated camera of mobile device 200a, it should be noted that digital camera 240 may be implemented using an external camera device communicatively coupled to mobile device 200a. The user for example may operate one or more keys of the keypad 220 to take a still image, which essentially activates the camera 240 to create a digital representation of an optical image visible to the image sensor through the lens of the camera. The camera 240 supplies the digital representation of the image to the microprocessor 212, which stores the representation as an image file in one of the device memories. The microprocessor 212 may also process the image file to generate a visible image output as a presentation to the user on the display 218, when the user takes the picture or at a later time when the user recalls the picture from device memory. An audio file or the audio associated with a video clip could be decoded by the microprocessor 212 or the vocoder 206, for output to the user as an audible signal via the speaker 204. As another example, upon command from the user, the microprocessor 212 would process the captured image file from memory storage to generate a visible image output for the user on the display 218. Video images could be similarly processed and displayed.

For purposes of discussion, FIG. 2B provides a block diagram illustration of an exemplary mobile device 200b having a touch-screen user interface. As such, mobile device 200b can be any smart mobile device (e.g., smart-phone or tablet device). Although possible configured somewhat differently, at least logically, a number of the elements of the exemplary touch-screen type mobile device 200b are similar to the elements of mobile device 200a, and are identified by like reference numbers in FIG. 2B. For example, the touch-screen type mobile device 200b includes a microphone 202, speaker 204 and vocoder 206, for audio input and output functions, much like in the earlier example. The mobile device 200b also includes a at least one digital transceiver (XCVR) 208, for digital wireless communications, although the mobile device 200b may include an additional digital or analog transceiver. The concepts discussed here encompass embodiments of the mobile device 200b utilizing any digital transceivers that conform to current or future developed digital wireless communication standards. As in mobile device 200a, the transceiver 208 provides two-way wireless communication of information, such as vocoded speech samples and/or digital information, in accordance with the technology of a network, as described above. The transceiver 208 also sends and receives a variety of signaling messages in support of the various voice and data services provided via the mobile device 200b and the communication network. Each transceiver 208 connects through RF send and receive amplifiers (not separately shown) to an antenna 210. The transceiver may also support various types of mobile messaging services, such as short message service (SMS), enhanced messaging service (EMS) and/or multimedia messaging service (MMS).

As in the example of mobile device 200a, a microprocessor 212 serves as a programmable controller for the mobile device 200b, in that it controls all operations of the mobile device 200b in accord with programming that it executes, for all general operations, and for operations involved in the procedure for obtaining operator identifier information under consideration here. Like mobile device 200a, mobile device 200b includes flash type program memory 214, for storage of various program routines and mobile configuration settings. The mobile device 200b may also include a non-volatile random access memory (RAM) 216 for a working data processing memory. Of course, other storage devices or configurations may be added to or substituted for those in the example. Hence, as outlined above, the mobile device 200b includes a processor, and programming stored in the flash memory 214 configures the processor so that the mobile device is capable of performing various desired functions, including in this case the functions associated with a client application executing on the mobile device, involved in the techniques for providing advanced data services by the carrier.

In the example shown in FIG. 2B, the user input elements for mobile device 200b include a touch-screen display 222 (also referred to herein as “display screen 222” or simply, “display 222”) and a keypad including one or more hardware keys 230. For example, the keypad may be implemented as a sliding keyboard of mobile device 200b and keys 230 may correspond to the keys of such a keyboard. Alternatively, the hardware keys 230 (including keyboard) of mobile device 200b may be replaced by soft keys presented in an appropriate arrangement on the touch-screen display 222. The soft keys presented on the touch-screen display 222 may operate similarly to hardware keys and thus, can be used to invoke the same user interface functions as with the hardware keys.

In general, the touch-screen display 222 of mobile device 200b is used to present information (e.g., text, video, graphics or other content) to the user of the mobile device. Touch-screen display 222 may be, for example and without limitation, a capacitive touch-screen display. In operation, touch-screen display 222 includes a touch/position sensor 226 for detecting the occurrence and relative location of user input with respect to the viewable area of the display screen. The user input may be an actual touch of the display device with the user's finger, stylus or similar type of peripheral device used for user input with a touch-screen. Use of such a touch-screen display as part of the user interface enables a user to interact directly with the information presented on the display.

Accordingly, microprocessor 212 controls display 222 via a display driver 224, to present visible outputs to the device user. The touch sensor 226 is relatively transparent, so that the user may view the information presented on the display 222. Mobile device 200b may also include a sense circuit 228 for sensing signals from elements of the touch/position sensor 226 and detects occurrence and position of each touch of the screen formed by the display 222 and sensor 226. The sense circuit 228 provides touch position information to the microprocessor 212, which can correlate that information to the information currently displayed via the display 222, to determine the nature of user input via the screen. The display 222 and touch sensor 226 (and possibly one or more keys 230, if included) are the physical elements providing the textual and graphical user interface for the mobile device 200b. The microphone 202 and speaker 204 may be used as additional user interface elements, for audio input and output, including with respect to some functions related to the automatic display shutoff override feature, as described herein.

Also, like mobile device 200a of FIG. 2A, the mobile device 200b in the illustrated example of FIG. 2B includes an integrated digital camera 240 for capturing still images and/or video clips. The user for example may operate one or more keys 230 or provide input via touch sensor 226 (e.g., via a soft key displayed via the touch-screen display 222) to take a still image, which essentially activates the camera 240 to create a digital representation of an optical image visible to the image sensor through the lens of the camera. The camera 240 supplies the digital representation of the image to the microprocessor 212, which stores the representation as an image file in one of the device memories. The microprocessor 212 may also process the image file to generate a visible image output as a presentation to the user on the display 222, when the user takes the picture or at a later time when the user recalls the picture from device memory.

The structure and operation of the mobile devices 200a and 200b, as outlined above, were described to by way of example, only. As shown by the above discussion, functions relating to the automatic display shutoff override may be implemented on a mobile device of a user, as shown by user device 110a of FIG. 1A and mobile devices 200a and 200b of FIGS. 2A and 2B, respectively. However, it should be noted that such functions are not limited thereto and that such functions also may be implemented using a general-purpose computing device including, for example, a personal desktop computer or workstation device communicatively coupled to a camera or other image capturing device for capturing digital images.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the automatic display shutoff override techniques as described herein. The software code is executable by the general-purpose computer. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for automatically disabling the auto-display shutoff feature of the computing device, in essentially the manner performed in the implementations discussed and illustrated herein.

The structure and operation of the mobile devices 200a and 200b, as outlined above, were described by way of example. For illustration purposes, the present teachings will be described below in reference to the touch-screen type mobile device 200b. However, it should be appreciated that these teachings are not limited thereto and that the disclosed subject matter may be implemented in a non-touch screen type mobile device (e.g., a mobile device 200a) or in other mobile or portable devices having communication and data processing capabilities. Examples of such mobile devices may include but are not limited to, net-book computers, tablets, notebook computers and the like.

In an example, mobile device 200b may include an automatic display shutoff feature, as described above. Such an auto-display shutoff feature generally operates by using a display timer that automatically may be set to a predetermined time period. Further, this feature of the device is generally triggered once a predetermined time period has elapsed and no user input has been detected during this period of time. For example, a display timer of mobile device 200b may be initialized to a predetermined amount/period of time (e.g., 30 seconds) in response to the activation of display 222. The predetermined amount/period of time may be one of the aforementioned mobile configuration settings for device 200b, e.g., stored in flash memory 214. Further, this setting may be global device setting that is configurable by the user at device 200b through an option in a settings panel or other configuration interface via touch-screen display 222. Alternatively, mobile device 200b may be preconfigured (e.g., by the device manufacturer or operating system developer) with a default time period for maintaining an active display. Once the predetermined time period set for the display timer has elapsed (e.g., display timer counts down to zero) and no activity or user input has been detected during the relevant time period (e.g., the user has not touched the touch-screen display 222 and thus touch-sensor 226 has not detected any user input), mobile device 200b may be configured to automatically shut off or deactivate the touch-screen display 222 (e.g., by dimming the screen or reducing the brightness level of display 222).

In order to improve user experience and alleviate problems associated with the auto-display shutoff feature of the mobile device (e.g., the display shutting off while the user is still viewing content being displayed), mobile device 200b may be configured to automatically disable or override the above-described auto-display shutoff feature. Mobile device 200b may include programming, e.g., stored in the flash memory 214, which may be used to configure the microprocessor 212 such that mobile device 200b may use face detection techniques, as described above with respect to FIGS. 1A and 1B, to automatically disable its auto-display shutoff feature/function.

In operation, one or more still images (e.g., image 114a of FIG. 1A, as described above) captured by camera 240 may be processed by microprocessor 212 for detecting at least a portion of a user's face. The images used by mobile device 200b for face detection may include, for example, one or more still images captured by camera 240. Further, the one or more images used for this purpose may be selected by device 200b from a series of images captured using camera 240. Additionally or alternatively, mobile device 200b may use camera 240 to capture a video. Thus, the aforementioned series of images may correspond to, for example, one or more frames from a video captured by camera 240.

In an example, camera 240 may be a front or forward-facing camera of the mobile device 200b. Thus, the detection of a human face by camera 240 may provide an indication to device 200b that the current user of the device (e.g., user 115 of FIGS. 1A and 1B) is currently viewing the display screen. The device 200b may rely, at least in part, on this indication for disabling the above-described auto-display shutoff feature, thereby keeping the display screen 222 active for the user. The device 200b may also use additional criteria to provide a better or more accurate indication that the user is facing or actively viewing the display screen. For example, the face detected by device 200b for this purpose may be from one or multiple angles or points of view relative to the position of camera 240 and/or device 200b. Thus, device 200b may be configured to disable the auto-display shutoff feature only when the front of the user's face is detected, as opposed to, for example, detecting a side of the user's face. As noted previously, device 200b may use any of various face detection algorithms for this purpose. Such algorithms may be used, for example, to detect facial features associated with a frontal view of a human face. Further, the algorithm may rely on the placement/position and measurements (e.g., within some tolerance factor) of possible features (e.g., position of two eyes relative to a mouth and/or nose) on a candidate of a face that may have been detected, based on processing of an image captured by camera 240.

In a further example, partial face detection may be sufficient for disabling the auto-display shutoff feature of device 200b. Such partial face detection may be dependent upon, for example, a predetermined threshold percentage (e.g., 50% or more) of a face that must be detected in order to qualify as an acceptable or sufficient partial detection of the face. In addition, device 200b may use a face detection algorithm in which a valid or successful partial detection of a face may be based on, for example, the facial features or candidates for such features that have been identified in an image captured by camera 240. For this purpose, the algorithm may assign relative confidence scores or rankings to each of the potentially identified features of a facial candidate identified in the image. Such a confidence score or ranking may also take into account various factors affecting the quality of the captured image including, for example, the degree of available lighting or amount of camera blur that may reduce the ability to identify distinct facial features or other portions of the image (e.g., background vs. foreground). It should be noted that the above-described algorithms for face detection, including partial face detection, are provided herein by way of example only and that the present teachings are not intended to be limited thereto.

To further improve user experience, mobile device 200b invokes camera 240 implementing the above-described functionality using face detection automatically and without any user intervention. However, as configuring camera 240 to be in an active state generally leads to increased power consumption and a reduction in battery life, mobile device 200b may be configured to limit the instances and duration that camera 240 is activated for purposes of disabling the auto-display shutoff feature using face detection. For example, mobile device 200b may use various criteria in determining whether the camera 240 should be activated or powered on for overriding the auto-display shutoff feature based on face detection. Examples of such criteria may include, but are not limited to, the amount of time that has elapsed since the last activity or input by the user (e.g., the current value of the display timer described above) and whether or not the particular application program executing at device 200b and currently outputting information to the display 222 has been previously selected or designated to be an application requiring the display to remain in an active state (which may be referred to herein as a “smart application”).

Further, the type of application executing at device 200b may affect the amount of user inactivity that is generally expected during typical use or operation of the application. For example, a relatively long period of inactivity (e.g., several minutes) without input from the user may be expected for a video streaming or video player application executing at device 200b. In contrast, a relatively short period of inactivity (e.g., one to two minutes) may be expected during the execution of an electronic reader (or e-reader) or similar type of application that generally involves frequent interaction by the user (e.g., to turn the page of an electronic book in a e-reader application). Therefore, the particular type of application currently executing and actively using display 222 to output information may be another criterion used by device 200b in determining when to activate camera 240 and trigger face detection. Accordingly, the application type may be used to determine an appropriate default value for the display timer or active display time window, which, for example, may be customized for each type of smart application executable at device 200b. Furthermore, the application type may affect particular characteristics or parameters of face detection including, for example, how relative confidence scores or rankings should be assigned to each of the potentially identified features of a candidate face in an image captured by camera 240, as described above. As such, the value of the confidence score assigned for facial detection during execution of an application may be related (e.g., proportional) to the period of inactivity generally expected for the particular type of application. Using the video player and e-reader examples above, camera 240 may need to detect a face for a relatively longer period of time in order for a face detection algorithm to assign a relatively high confidence score for the detected face during execution of the video player application, whereas camera 240 may need to detect the face for a relatively short duration in order for the algorithm to assign the same or similar high confidence score during execution of the e-reader application.

With respect to such smart applications, device 200b may provide an interface enabling the user to designate or select one or more installed applications to be smart applications, the execution of which causes the device 200b to override the auto-display shutoff feature using face detection. Such an interface may include, for example, a list comprising all or a subset of the user applications installed at device 200b. Alternatively, device 200b may be preconfigured to designate one or more installed user-level applications as smart applications based on whether the particular application(s) are generally known to involve prolonged use of display 222 or prolonged viewing by the user of the display screen during normal or default operation. Examples of general user applications that may qualify as smart applications include, but are not limited to, electronic book (e-book) reader applications, electronic document viewers, applications for viewing video or other multimedia content, or any other application that may involve a prolonged period of inactivity during which the display screen must remain active for the user to view content or information displayed by the application during its general use.

Thus, mobile device 200b may be configured to activate camera 240 and attempt to detect at least a portion of a human face only when a combination of the above-described criteria are satisfied. If mobile device 200b has determined to activate the camera 240 for enabling face detection based on the above-described criteria (e.g., display 222 is active and a smart application is currently executing), mobile device 200 may use additional criteria to determine whether a face has been detected successfully for purposes of overriding the auto-display shutoff feature of the device. An example of such additional criteria may include, but is not limited to, the amount of distance between the device 200b (or camera 240) and the person's face. The amount of distance may be configurable by the user, for example, via a user option provided in a settings panel of the device, as described above. However, the actual distance needed to capture the image(s) for face detection may be limited, for example, by the particular type or capabilities of the camera 240 implemented in device 200b as well as the available lighting when the image(s) are being captured. In some implementations, mobile device 200b may utilize a camera light or flash bulb (e.g., implemented using an light emitting diode (LED) bulb), which may be used to increase the amount of distance or distance range needed for sufficient face detection and/or improve picture quality in low-light situations. In addition, the face detection algorithm itself may set or limit distances based on the type of device or the size of the display screen that may be used by the device. More specifically, a relatively larger distance (e.g., greater than a one-foot/0.3-meter distance) may be acceptable for face detection with respect to devices that tend to have relatively larger displays for viewing content (e.g., a desktop computer coupled to a front-facing camera and CRT or LCD display monitor). However, it is unlikely that a facial image captured at such a large distance by a camera of a mobile device having a relatively small display (e.g., more than about a foot from a mobile phone) would be indicative of someone actually viewing any content being displayed.

Another example of a criterion that may be used by mobile device 200b in determining whether the auto-display-shutoff function should be disabled includes the amount of time a person's face is detected. In addition, this may necessitate the capture of multiple images via camera 240 within a relatively short amount of time. This criterion helps to prevent situations in which the auto-display shutoff function from being disabled prematurely, for example, in cases where the user happens to face the camera 240 only for a brief period of time immediately after face detection using camera 240 has been activated. Accordingly, mobile device 200b may be configured to override the auto-display shutoff function only after a user's face has been detected for a predetermined period of time. Like the distance criterion in the previous example, the time period for face detection may also be a configurable user option. In yet another example of a criterion for determining whether to disable or override the auto display shutoff function, the mobile device 200b may make the determination based on partial face detection. For example, the mobile device 200b may be configured such that particular portions or features must be detected before face detection has successfully occurred. Additionally or alternatively, the mobile device 200b may use a predetermined threshold value, for example, a predetermined percentage of the user's face that must be detected in order to override the auto-display shutoff feature of the device. This criterion may also be configurable by the user, similar to the above-described criteria, or may be preconfigured based on, for example, the particular algorithm used to implement this partial face detection functionality at device 200b.

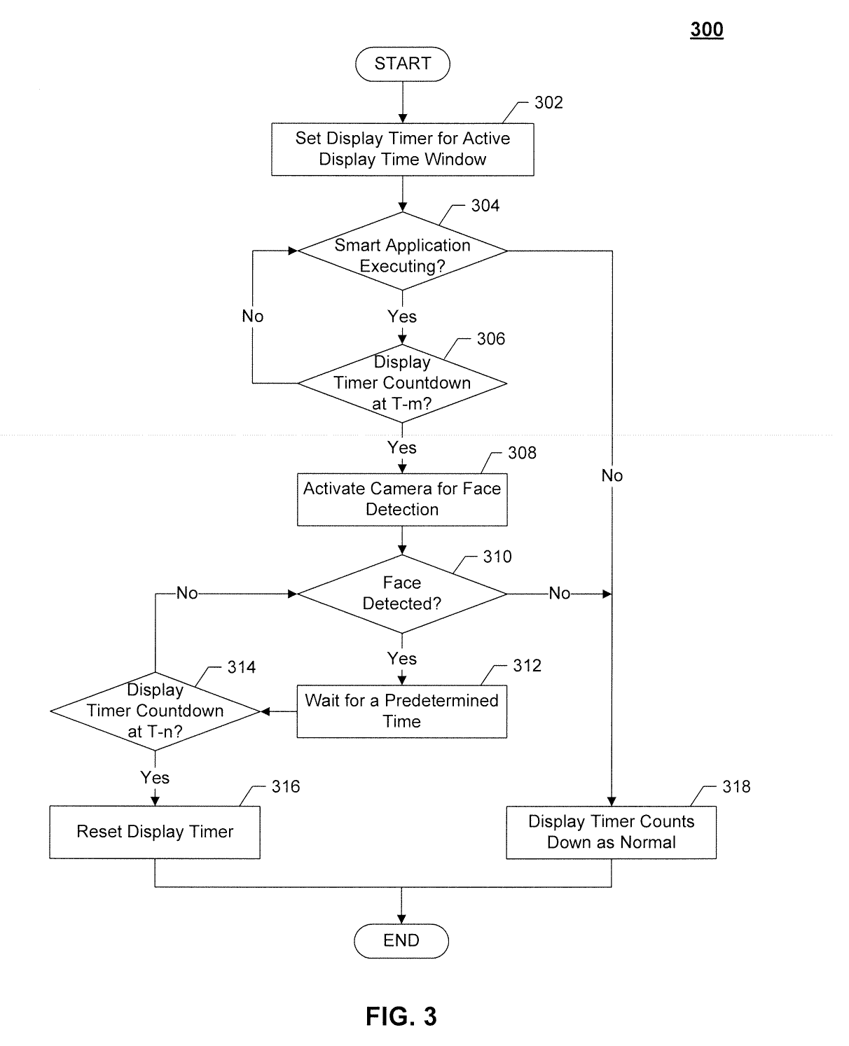

As will be described in further detail below with respect to the process flowchart of FIG. 3, once the device 200b has determined that a face (or portion thereof) has been detected successfully, mobile device 200b may be configured to reset the display timer so as to disable or override the auto-display shutoff feature of the device.

FIG. 3 is a process flowchart of an example method 300 for automatically disabling the automatic display shutoff feature or function of a computing device using face detection. For purposes of discussion, method 300 will be described using the example devices 110a-b of FIGS. 1A and 1B and example devices 200a and 200b of FIGS. 2A and 2B, respectively, as described above. However, method 300 is not intended to be limited thereto. Thus, the steps of method 300 as will be described below may be performed by, for example, user device 110a, user device 110b, mobile device 200a or mobile device 200b.

In step 302 of the example flowchart shown in FIG. 3, upon determining that a display of the device (e.g., display 222 of device 200b, as described above) is currently active or powered on, the corresponding display timer is initialized to a predetermined time period or window. As described above, the display timer may be implemented as a countdown timer, the expiration of which causes the automatic display shutoff feature of the device to be invoked. Method 300 may then proceed to step 304, which includes determining whether the application that is currently being executed at the device (e.g., by microprocessor 212 of mobile device 200b) and also outputting information to the display (e.g., display 222 of device 200b) has been designated or pre-selected as a smart application (e.g., by the user via an interface at the device), as described above. If the application program being executed can be identified as a smart application is currently executing, method 300 proceeds to steps 306 and 308 for determining whether to activate the camera of the device for enabling face detection. Step 306 includes determining whether the display timer has reached a predetermined point in time (e.g., T-minus ‘m’ seconds) prior to the end of the active display time window and the expiration of the active display timer, initialized earlier in step 302. This predetermined point may be, for example, a configurable option or setting that may be adjusted (e.g., by the user) as desired. For example, the active display timer countdown may be initialized to a 30-second window, and face detection may be set to active at T-minus 5 seconds prior to the display timer countdown reaching 0 (i.e., after 25 seconds has elapsed). A benefit of making the above-described determination in step 306 for activating the camera and the face detection functionality of the device is that it helps to minimize any additional power consumption associated with activating the camera for face detection too early during the active display time window.

Thus, step 308 includes activating the front-facing digital camera of the device (e.g., camera 240 of device 200b, as described above) for enabling face detection (step 310), only after the display timer reaches this predetermined point in the active display time window and at least one smart application is still executing at the device. In a case where multiple smart applications may be executing at the device simultaneously, the relevant smart application for purposes of disabling the auto-display shutoff function may be the application for which the display screen is primarily being used to display content output from that application at a current point in time. The relevant smart application in this case would also be the application the user is actively using at the current time, where any other smart applications executing at the device may be in an idle state or executing only as background process. However, if it is determined in step 304 that no smart applications are currently executing, method 300 proceeds to step 318, in which the auto-display shutoff function of the device is not disabled and accordingly, the active display timer counts is allowed to count down as under normal or default operation.

In step 310, the camera of the device is activated for face detection and it is determined whether a face has been detected successfully for purposes of disabling the auto-display shutoff feature of the device. This determination may be based on, for example, one or more of the additional criteria, as described above, including, but not limited to, the amount of distance between the device and the user's face and if partial face detection is supported, whether a sufficient portion of the user's face has been detected. In the example shown in FIG. 3, if a face has been detected successfully in step 310, method 300 may proceed to steps 312 and 314 for implementing an additional criterion related to the amount of time the user's face is being detected, as described above. This criterion provides an additional check as to whether the detected face actually provides an indication that the user is actively viewing the display, and thereby avoiding cases in which the user happened to be glancing very briefly but at a time immediately following the predetermined point in the active display window for activating the camera for face detection, also as described above. Accordingly, steps 312 and 314 include waiting a predetermined time, for example, until the display timer countdown reaches another predetermined point or time limit (e.g., T-minus ‘n’ seconds), after which method 300 proceeds to step 316. In step 316, the active display timer is reset automatically before the auto-display shutoff feature is triggered so as to effectively disable (temporarily) this shutoff feature.

If the display timer is implemented as a countdown timer, for example, then this second point of time during the active display window (corresponding to the value of ‘n’ in step 314) should be less than the value of ‘m’ in step 306. Like the predetermined time described above with respect to step 306, this predetermined time may also be a configurable option or setting that may be adjusted as desired. In an example, the predetermined waiting time used in step 312 may be 1 second and the value of ‘n’ in step 314 may be set to 2 seconds prior to the expiration of the display timer countdown (e.g., before this countdown reaches 0). As such, the predetermined amount of time the user's face must be detected is 3 seconds. In this example, the display timer is reset automatically without triggering the auto-shutoff function (step 316), only when the user's face has been detected (step 310) for a period of at least 3 seconds (steps 312 and 314) starting at T-minus 5 seconds prior to the expiration of the active display time window (step 306), until T-minus 2 seconds prior to the expiration of the time window (step 314). Otherwise, if a face has not been detected for the predetermined period of time (e.g., at least 3 seconds) before the display timer reaches a predetermined limit (e.g., T-minus 2 seconds), method 300 proceeds to step 318 in which the display timer continues to run (e.g., count down to 0) until the default active display time window has expired and the auto-display shutoff feature of the device is triggered as under normal operation of the device.

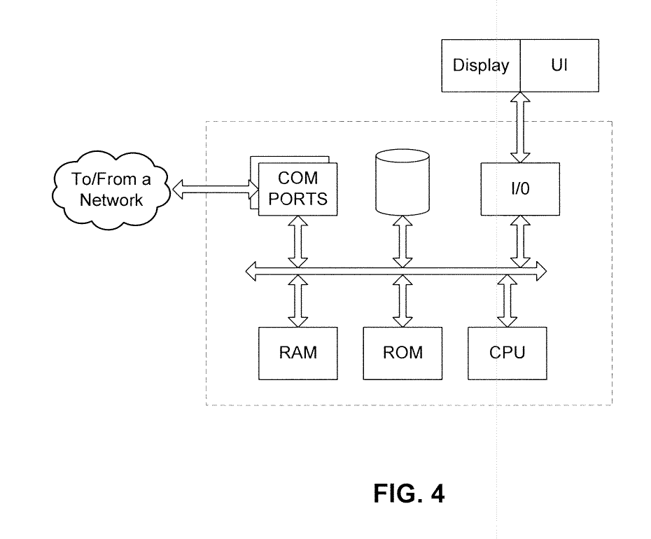

FIG. 4 depicts a computer with user interface elements, as may be used to implement a personal computer or other type of work station or terminal device. It is believed that the general structure, programming and general operation of such computer equipment are well-known and as a result the drawings should be self-explanatory. A computer or computing device, for example, includes a data communication interface for packet data communication. The computer also includes a central processing unit (CPU), in the form of one or more processors, for executing program instructions. As shown in FIG. 4, the computing platform typically includes an internal communication bus, program storage and data storage for various data files to be processed and/or communicated by the computer, although the computer often receives programming and data via network communications. Such computers may use various conventional or other hardware elements, operating systems and programming languages. Of course, the computer functions may be implemented in a distributed fashion on a number of similar platforms, to distribute the processing load.

Aspects of method 300 of FIG. 3 and the techniques for disabling an auto-display shutoff feature of the computing device, as described above with respect to FIGS. 1A, 1B, 2A and 2C, may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of FIG. 4. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement techniques for disabling the auto-display shutoff feature of the computing device, as described above. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. The specification and drawings are accordingly to be regarded in an illustrative rather than restrictive sense.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A user device, comprising:
a display;
a user input element;
a camera facing forward in a direction from which a user would view the display;
a processor coupled to the display, the user input element and the camera;
a storage device accessible to the processor; and
application programs in the storage device, execution of each of the application programs by the processor configuring the user device to present information for the user on the display;
wherein the processor is configured to perform functions comprising:
an automatic display shutoff function to terminate display of information from execution of one of the application programs and shutoff the display, when no user input via the user input element is detected for a period of time,
a face detection function to detect at least a portion of a face in an image taken by the camera, and
an override function to override the automatic display shutoff function, keep the display in an active state so as to continue the display of information during execution of a smart application program to enable the override function, when the processor detects the face before expiration of the period of time without detecting a user input via the user input element.

2. The device of claim 1, wherein:
the smart application program is associated with the display of information for a time longer than the period of time, and
the processor is further configured to identify the one of the application programs as a smart application program and, in response to the identification, to implement the override function.

3. The device of claim 1, wherein the processor is further configured to:
estimate a distance between the detected face and the device; and
override the automatic display shutoff function when the estimated distance between the detected face and the device is less than or equal to a threshold distance.

4. The device of claim 3, wherein the threshold distance is based on a size of the display.

5. The device of claim 1, wherein the processor is further configured to:
determine a length of time the face has been detected; and
override the automatic display shutoff function when the determined length of time of face detection is greater than or equal to a threshold period of time.

6. The device of claim 5, wherein the threshold period of time is based on a type of the smart application program.

7. The device of claim 1, wherein the face detection function includes a function to determine that at least a predetermined minimum percentage of a face is detected.

8. A method of controlling operation of a user device, comprising steps during active output of information for a user via a display of the user device, the steps including:
monitoring a predetermined amount of time since receiving an input from the user at the device, the predetermined amount of time corresponding to an active display timer for an automatic display shutoff function of the device activated based on inactivity longer than the predetermined amount of time;
determining whether an application program executing on a processor of the device causing generation of the information being output via the display is associated with a predefined set of application programs selected from among all of the application programs stored in the device;
responsive to the determination that the executing application program is from the predefined set, processing an image, captured by a camera of the device facing forward in a direction from which a user would view the display to detect a face; and
responsive to the face detection, overriding the automatic display shutoff function of the device so as to keep the display in an active state and enable the user to continue viewing the information being output by the executing application program via the display.

9. The method of claim 8, wherein the application programs in the predefined set are application programs associated with displaying information via the display for a time longer than the predetermined amount of time for the active display timer.

10. The method of claim 9, further comprising:
providing an interface for the user to select the predefined set of application programs from among the application programs stored in the device.

11. The method of claim 8, wherein the overriding step further comprises:
estimating a distance between the detected face and the device; and
overriding the automatic display shutoff function of the device when the estimated distance between the detected face and the device is less than or equal to a predetermined threshold distance.

12. The method of claim 11, wherein the threshold distance is predetermined based on a size of the display.

13. The method of claim 8, wherein the overriding step further comprises:
determining a length of time the face has been detected; and
overriding the automatic display shutoff function of the device when the determined length of time of face detection is greater than or equal to a predetermined threshold period of time.

14. The method of claim 13, wherein the threshold period of time is predetermined based on a type of the smart application program.

15. The method of claim 8, wherein the overriding step further comprises:
determining that at least a predetermined minimum percentage of a face is detected; and
overriding the automatic display shutoff function of the device upon determining that at least the predetermined minimum percentage of the face is detected.

16. An article of manufacture, comprising a non-transitory computer-readable medium and computer-executable instructions embodied in the medium that, if executed by a computing device, cause the computing device to perform functions including functions to:
automatically deactivate a display of the computing device while information is being displayed from execution of application programs stored in the computing device, wherein the display is deactivated when no user input via a user input element of the computing device is detected for a predetermined period of time of inactivity;
detect at least a portion of a face in an image taken by a camera of the computing device; and
override the automatic deactivation of the display and keep the display in an active state so as to enable the user to continue viewing the information being displayed during execution of a smart application program at the computing device, the application program causing the automatic deactivation of the display to be overridden, when the face is detected before expiration of the predetermined period of time of inactivity without detecting a user input via the user input element.

17. The article of claim 16, wherein the smart application program is associated with the display of information for a time longer than the period of time, and the override function performed by the computing device includes functions to:
identify the one of the application programs as a smart application program; and
in response to the identification, implement the override function.

18. The article of claim 16, wherein the functions performed by the computing device further include functions to:
estimate a distance between the detected face and the device; and
override the automatic deactivation of the display when the estimated distance between the detected face and the device is less than or equal to a threshold distance.

19. The article of claim 16, wherein the functions performed by the computing device further include functions to:
determine a length of time the face has been detected; and
override the automatic deactivation of the display when the determined length of time of face detection is greater than or equal to a threshold period of time.

20. The article of claim 16, wherein the face detection function includes a function to determine that at least a predetermined minimum percentage of a face is detected.
